(19) United States
(12) Patent Application Publication
(10) Pub. No.: US 2021/0197484 A1
(43) Pub. Date: Jul. 1, 2021

(54) HEATING SOURCE OPERATION FOR THREE DIMENSIONAL OBJECT FABRICATION

(71) Applicant: HEWLETT-PACKARD DEVELOPMENT COMPANY, L.P., Spring, TX (US)

(72) Inventors: David E. SMITH, Vancouver, WA (US); Arthur H. BARNES, Vancouver, WA (US)

(73) Assignee: HEWLETT-PACKARD DEVELOPMENT COMPANY, L.P., Spring, TX (US)

(21) Appl. No.: 16/075,640

(22) PCT Filed: Apr. 20, 2017
(86) PCT No.: PCT/US2017/028513

§ 371 Date: Aug. 4, 2018

(51) Int. Cl. B29C 64/393; B29C 64/264; B29C 64/295

(52) U.S. Cl. CPC B29C 64/393; B33Y 50/02; B29C 64/295; B29C 64/264

(57) ABSTRACT

A method for fabricating three dimensional objects herein can include calibrating a system to detect a temperature component and a current component by operating a heating source with at least two different calibration voltages and monitoring a color temperature of the heating source and an optical power of the heating source at each of the at least two different calibration voltages. The method can also include performing a three dimensional printing operation while applying a fabrication voltage to the heating source and monitoring the fabrication voltage and a current of the heating source during the three dimensional printing operation. Furthermore, the method can include adjusting the fabrication voltage of the heating source in response to a change in a resistance of the heating source or a characteristic of the three dimensional object, wherein the fabrication voltage is adjusted based at least on the temperature component and the current component.

### BACKGROUND

Fabrication devices can produce three dimensional objects using a range of three dimensional printing techniques. In some examples, fabrication devices can include three dimensional printers that can produce three dimensional objects by melting any number of layers of different materials. In some examples, the three dimensional printers can use any suitable heat source, such as a light bulb, among others, to generate the heat to melt each layer.

### DESCRIPTION OF THE DRAWINGS

Certain examples are described in the following detailed description and in reference to the drawings, in which:

FIG. 1 is a block diagram of an example system with a heating source that is used to fabricate a three dimensional object;

FIG. 2 is a process flow diagram for fabricating a three dimensional object;

FIG. 3 is a block diagram of an example computing system that can fabricate a three dimensional object; and

FIG. 4 is a non-transitory computer-readable medium that can provide instructions to fabricate a three dimensional object.

### DETAILED DESCRIPTION

In examples described herein, a fabrication device can fabricate or generate three dimensional objects using various techniques. In some examples, the fabrication device is a three dimensional printer that can generate an object by melting and fusing a number of layers of material. In some examples, each layer of material can be melted using heating sources that reside in a lamp carriage. Each heating source can use any suitable type of bulb, such as infrared quartz tungsten bulbs, or any suitable thermic source. The heating sources can generate heat to melt a layer of material, which fuses the layer to previously melted and solidified layers. In some examples, the temperature in the operating environment of the heating source can vary during the fabrication process. For example, as the heating sources generate heat for an extended period of time, the temperature proximate the heating sources can increase. Additionally, the temperature can increase as heat generated from heating sources remains in a closed area such as a lamp carriage. The change in temperature of the operating environment of a heating source can change the resistance of the heating source, which can affect the optical power or output of the heating source.

The techniques described herein can enable a fabrication device to generate a constant color temperature and power output by varying the voltage provided to a heating source. For example, the fabrication device can include a processor that can calibrate a fabrication system to detect a temperature component and a current component by operating a heating source with at least two different calibration voltages. In some examples, the calibration process can also include monitoring a color temperature of the heating source and an optical power of the heating source at each of the at least two different calibration voltages. The temperature component and the current component can be used by the processor to modify a voltage provided to a heating source during the fabrication process. In some examples, the processor can also perform a three dimensional printing operation while applying a fabrication voltage to the heating source. Additionally, the processor can monitor the fabrication voltage and a current of the heating source during the fabrication of the three dimensional object or the three dimensional printing operation. Furthermore, the processor can adjust the fabrication voltage of the heating source in response to a change in a resistance of the heating source or a characteristic of the three dimensional object, wherein the fabrication voltage is adjusted based at least on the temperature component and the current component.

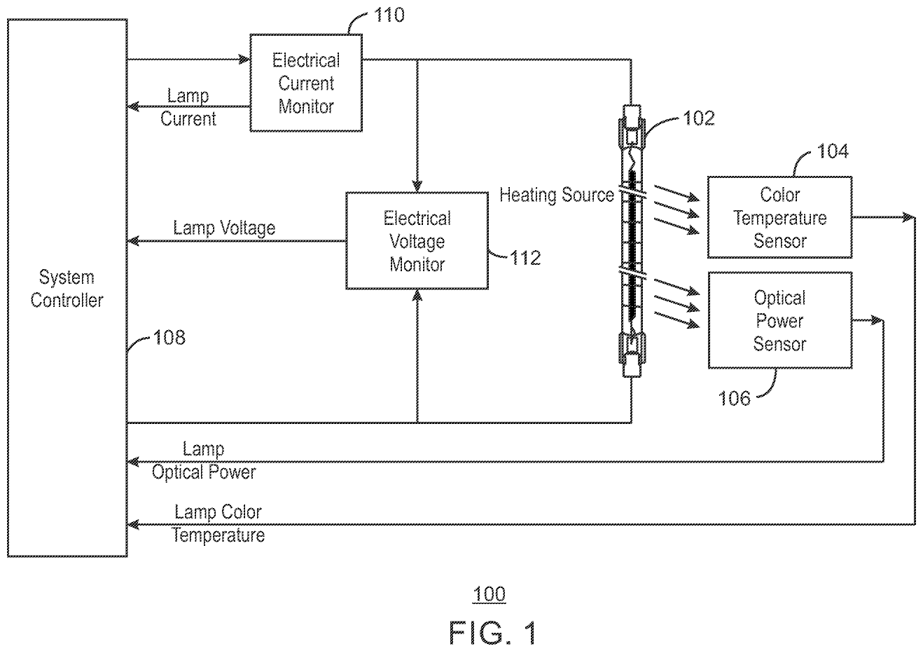

FIG. 1 is a block diagram of an example system 100 with a heating source that is used to fabricate a three dimensional object. A heating source 102, as referred to herein, can include any suitable bulb that can generate heat to melt a layer of material. For example, the heating source 102 can include an infrared quartz halogen bulb, among others. In some examples, the heating source 102 of system 100 can reside in a lamp carriage (not depicted) that may include any suitable number of lamps. The heating sources in the lamp carriage can be used together to generate heat to melt a layer of material. In some examples, the layer of material can include a powder that is melted with the heating sources to produce a solid layer of a three dimensional object. In some examples, any suitable number of layers of material can be melted and fused to form a three dimensional object.

In some examples, the heating source 102 can be monitored by any suitable number of sensors during a calibration process. For example, a color temperature sensor 104 and an optical power sensor 106 can detect characteristics of the heating source 102. In some examples, the color temperature sensor 104 and the optical power sensor 106 can detect characteristics for each heating source in a lamp carriage or separate color temperature and optical power sensors can be assigned to each heating source. The color temperature characteristic of a heating source 102, as referred to herein, can indicate a warmth or a coolness of the heating source. The color temperature can indicate the spectral power distribution or an amount of power emitted at each wavelength in the electromagnetic spectrum. For example, yellow-red colors can be considered cool and blue-green colors can be considered warm. In some examples, the color temperature characteristic of a heating source 102 can indicate a shift in color temperature and a corresponding shift in spectral power distribution in relation to a black body radiation curve. The color temperature characteristic 102 may also correspond to near and mid infrared regions, which are not visible.

In some examples, the optical power sensor 106 can detect information regarding the amount of light produced by the heating source 102. For example, the optical power sensor 106 can detect an amount of luminous flux generated by the heating source 102 based on an amount of light emitted per a period of time in a predetermined angle from the heating source 102. In some examples, the optical power sensor 106 may detect visible optical power. In some examples, the optical power sensor 106 and the color temperature sensor 104 can detect values for any suitable number of voltages applied to a heating source 102 during the calibration process. In some examples, two voltages may be applied to the heating source 102 with a system controller 108, which can result in two color temperature values and two optical power values.

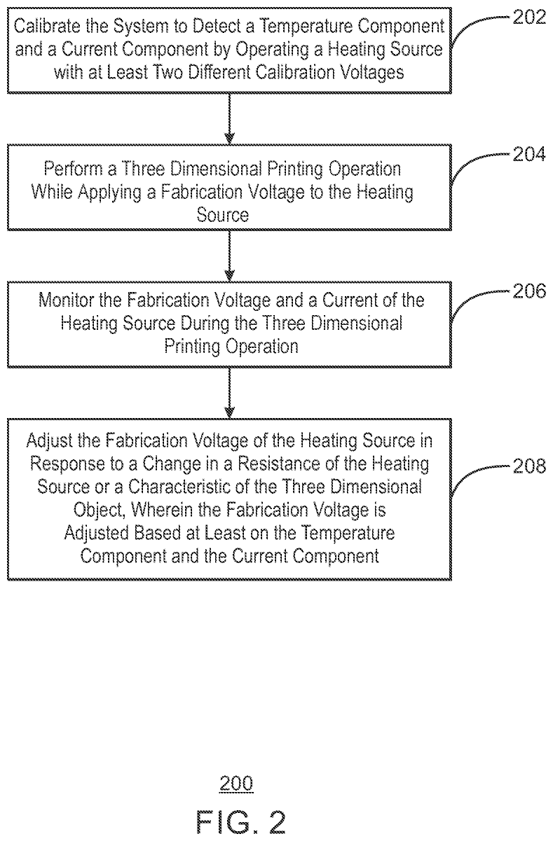

In some examples, the system controller 108 can turn off the color temperature sensor 104 and the optical power sensor 106 in response to detecting the color temperature values and the optical power values and transmitting the optical power values and the color temperature values for the heating source 102 to the system controller 108. Accordingly, the system controller 108 can operate the heating source 102 during fabrication of a three dimensional object without sensors. The system controller 108 can apply an initial voltage or a fabrication voltage to the heating source 102. The system controller 108 can monitor an electrical current of the heating source with an electrical current monitor 110 and monitor an electrical voltage of the heating source with an electrical voltage monitor 112 during fabrication of a three dimensional object. The system controller 108 can use the electrical current and electrical voltage values to adjust a voltage applied to the heating source 102 based on calculations described in greater detail below in relation to FIG. 2.

It is to be understood that the example system 100 illustrated in FIG. 1 can include additional components or a fewer number of components. For example, the system 100 may also include a lamp carriage in which the heating source resides. In some examples, the lamp carriage can include any suitable number of heating sources. Additionally, the system 100 can include any suitable number of color temperature sensors and optical power sensors. For example, the system 100 may include a separate color temperature sensor and optical power sensor for each heating source in a lamp carriage. Furthermore, the system 100 can include any suitable number of processors and storage components. In some examples, the storage components can store the voltages provided to the heating source 102 for each layer of a fabricated three dimensional object.

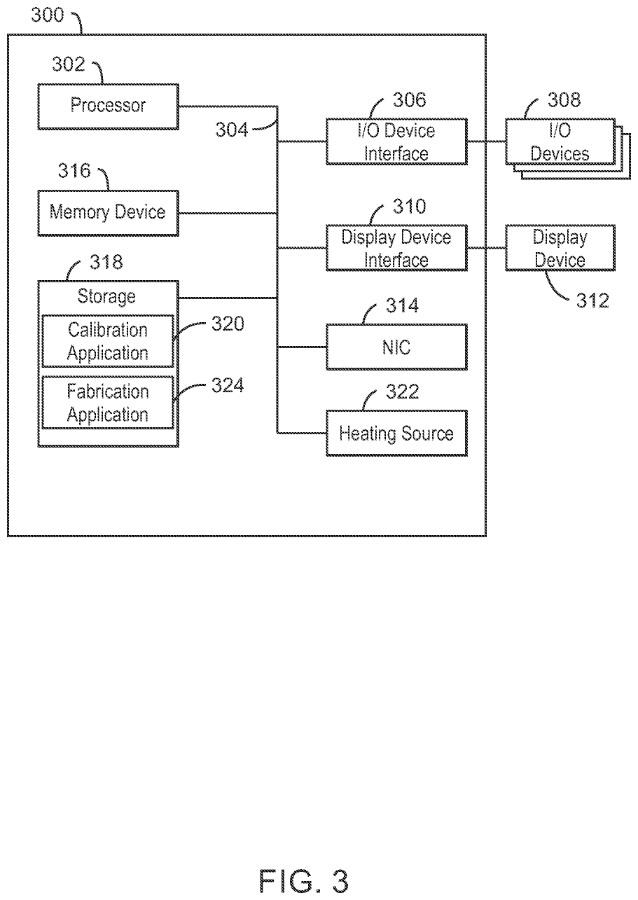

FIG. 2 is a process flow diagram for fabricating a three dimensional object. The process 200 can be implemented by any suitable computing device such as the computing system 300 of FIG. 3 described below or the system controller 108 of FIG. 1. In some examples, the process 200 can include fabricating a three dimensional object with any suitable manufacturing technique or three dimensional printing technique.

At block 202, the process 200 can include calibrating a system to detect a temperature component and a current component by operating a heating source with at least two different calibration voltages. In some examples, calibrating a system can also include monitoring a color temperature of the heating source and an optical characteristic, such as optical power, among others, of the heating source at each of the at least two different calibration voltages. As discussed above, the color temperature of a heating source can indicate a warmth or a coolness of the heating source. The optical power can indicate an amount of luminous flux generated by a heating source based on an amount of light emitted per a period of time at a predetermined angle from the heating source. In some examples, the optical power values and the color temperature values corresponding to the calibration voltages of the heating source can be used to detect several unknown values such as a nominal voltage V₀ of the heating source, a nominal color temperature T₀ of the heating source, and a nominal optical power L₀ of the heating source, among others. By determining these unknown values, a system controller or computing system can adjust the voltage applied to a heating source during fabrication of a three dimensional object as a resistance of the heating source changes.

In some examples, the process 200 can include calculating unknown values using any suitable mathematical technique. In the example process 200, Equations 1-20 below calculate various values corresponding to a heating source, which enable adjusting a voltage provided to a heating source during fabrication of a three dimensional object without feedback or sensor data from sensors.

In some examples, the color temperature of a heating source can be defined based on Equations 1-10 below. For example, Equation 1 can indicate a calculation of a color temperature of a heating source. In some examples, the color temperature represents a measurement in Kelvin, or any other suitable unit.

$$T = {{T}_{0} ( \frac{R}{{R}_{0}} )}^{\frac{{K}_{T}}{1 - {K}_{I}}} \qquad Eq . 1$$

In some examples, the variable K_{I} is calculated based on Equation 2 below, wherein V₁ and V₂ are two different voltages applied to the heating source during calibration. In some examples, the process 200 can include detecting a nominal resistance R₀ using Equation 6 below based on the at least two different voltages V₁ and V₂. In addition, Equation 7 below can indicate a constant value K_{T} to be included in Equation 1, and Equation 8 can be used to indicate a color temperature value T₀ to be included in Equation 1.

$${K}_{I} = \frac{ln ( {I}_{2} ) - ln ( {I}_{1} )}{ln ( {V}_{2} ) - ln ( {V}_{1} )} \qquad Eq . 2$$

In some examples, the variables I₁ and I₂, corresponding to a current of the heating source at each calibration voltage, are calculated based on Equations 3, 4, and 5 below. The variable V₀ indicates a voltage of a heating source at any suitable time.

$$\begin{matrix}{I}_{0} = {{I}_{2} ( \frac{{V}_{0}}{{V}_{2}} )}^{\frac{ln ( \frac{{I}_{2}}{{I}_{1}} )}{ln ( \frac{{V}_{2}}{{V}_{1}} )}} & Eq . 3 \\ {I}_{1} = {{I}_{0} ( \frac{{V}_{1}}{{V}_{0}} )}^{{K}_{I}} & Eq . 4 \\ {I}_{2} = {{I}_{0} ( \frac{{V}_{2}}{{V}_{0}} )}^{{K}_{I}} & Eq . 5\end{matrix}$$

In some examples, the resistance of the heating source is calculated by detecting a value for R₀ as indicated in Equation 6 below. The resistance value R₀ can be a measurement in Ohms or any other suitable unit.

$${R}_{0} = \frac{{V}_{0}}{{I}_{0}} \qquad Eq . 6$$

In some examples, the variable K_{T} is a constant related to color temperature that is calculated by Equation 7 below.

$${K}_{T} = \frac{ln ( {T}_{2} ) - ln ( {T}_{1} )}{ln ( {V}_{2} ) - ln ( {V}_{1} )} \qquad Eq . 7$$

In some examples, Equations 8, 9, and 10 below indicate color temperature values of the heating source based on different voltages V₁ and V₂ applied to the heating source during the calibration process. The nominal temperature color of the heating source is defined as T₀ in Equation 8 below.

$$\begin{matrix}{T}_{0} = {{T}_{2} ( \frac{{V}_{0}}{{V}_{2}} )}^{\frac{ln ( \frac{{T}_{2}}{{T}_{1}} )}{ln ( \frac{{V}_{2}}{{V}_{1}} )}} & Eq . 8 \\ {T}_{1} = {{T}_{0} ( \frac{{V}_{1}}{{V}_{0}} )}^{{K}_{T}} & Eq . 9 \\ {T}_{2} = {{T}_{0} ( \frac{{V}_{2}}{{V}_{0}} )}^{{K}_{T}} & Eq . 10\end{matrix}$$

In some examples, the optical power of a heating source can be defined based on similar equations. For example, the optical power (also referred to herein as a current component) of a heating source, L, can be calculated based on Equation 11 below. The optical power of a heating source can be a measurement in Lumens, or any other suitable unit.

$$L = {{L}_{0} ( \frac{R}{{R}_{0}} )}^{\frac{{K}_{L}}{1 - {K}_{I}}} \qquad Eq . 11$$

The variables R₀, K_{L}, K_{I}, and L₀ can be calculated using Equations 12 through 20 below. Equations 12-20 are similar to Equations 2-10, but the color temperature values T₀, T₁, and T₂ are substituted with optical power values L₀, L₁, and L₂.

$$\begin{matrix}{K}_{1} = \frac{ln ( {I}_{2} ) - ln ( {I}_{1} )}{ln ( {V}_{2} ) - ln ( {V}_{1} )} & Eq . 12 \\ {I}_{0} = {{I}_{2} ( \frac{{V}_{0}}{{V}_{2}} )}^{\frac{ln ( \frac{{I}_{2}}{{I}_{1}} )}{ln ( \frac{{V}_{2}}{{V}_{1}} )}} & Eq . 13 \\ {I}_{1} = {{I}_{0} ( \frac{{V}_{1}}{{V}_{0}} )}^{{K}_{I}} & Eq . 14 \\ {I}_{2} = {{I}_{0} ( \frac{{V}_{2}}{{V}_{0}} )}^{{K}_{I}} & Eq . 15\end{matrix}$$

In some examples, the nominal resistance of the heating source is calculated by detecting a value for R₀ as indicated in Equation 16 below.

$${R}_{0} = \frac{{V}_{0}}{{I}_{0}} \qquad Eq . 16$$

In some examples, the variable K_{L} is a constant related to optical power that is calculated by Equation 17 below.

$${K}_{L} = \frac{ln ( {L}_{2} ) - ln ( {L}_{1} )}{ln ( {V}_{2} ) - ln ( {V}_{1} )} \qquad Eq . 17$$

In some examples, Equations 18, 19, and 20 below indicate optical power values of the heating source based on different voltages V₁ and V₂ applied to the heating source during the calibration process. The optical power of the heating source is defined as L₀ in Equation 18 below.

$$\begin{matrix}{L}_{0} = {{L}_{2} ( \frac{{V}_{0}}{{V}_{2}} )}^{\frac{ln ( \frac{{L}_{2}}{{L}_{1}} )}{ln ( \frac{{V}_{2}}{{V}_{1}} )}} & Eq . 18 \\ {L}_{1} = {{L}_{0} ( \frac{{V}_{1}}{{V}_{0}} )}^{{K}_{L}} & Eq . 19 \\ {L}_{2} = {{L}_{0} ( \frac{{V}_{2}}{{V}_{0}} )}^{{K}_{L}} & Eq . 20\end{matrix}$$

The various values calculated at block 202 can be used to adjust the voltage applied to a heating source at block 208 below. For example, the color temperature value T and optical power value L for a heating source can enable adjusting the voltage applied to a heating source to maintain a constant resistance level in the heating source as an environmental temperature proximate the heating source changes.

At block 204, the process 200 can also include performing a three dimensional printing operation while applying a fabrication voltage to the heating source. For example, the process 200 can initiate a fabrication of the three dimensional object with any suitable voltage. In some examples, the fabrication voltage can correspond to an initial voltage to be applied to a first layer of material of a three dimensional object. In some examples, the fabrication voltage corresponds to a room temperature environment in which the heating source resides. For example, the fabrication voltage may be applied when a fabrication device has not been recently utilized.

At block 206, the process 200 can include monitoring the fabrication voltage and a current of the heating source during the three dimensional printing operation or fabrication of the three dimensional object. For example, the process 200 can include monitoring the electrical current of the heating source and the electrical voltage of the heating source as a three dimensional object is fabricated. In some examples, the process 200 can include monitoring the electrical current and electrical voltage of a heating source using any suitable monitors or components located along the electrical lines providing a voltage to the heating source. As discussed above, the temperature of the environment surrounding the heating source may change as the three dimensional object is fabricated, which can result in a resistance of the heating source changing as well. By monitoring the fabrication voltage and the current of the heating source during the fabrication process, a system controller or a computing device can determine if the fabrication voltage is to be adjusted or modified as described below at block 208 in greater detail.

At block 208, the process 200 can include adjusting the fabrication voltage of the heating source in response to a change in a resistance of the heating source or a characteristic of the three dimensional object, wherein the fabrication voltage is adjusted based at least on the temperature component and the current component. In some examples, the temperature component is equal to T calculated by Equation 1 using the temperature exponent K_{T}. In some examples, the current component (also referred to herein as optical power component) is equal to L calculated by Equation 11 using the current or optical power exponent K_{L}. The temperature and current values of T and L can be recalculated as the resistance of the heating source changes during fabrication of a three dimensional object. In some examples, the temperature and current values of T and L can be continuously calculated or the temperature and current values of T and L can be calculated at predetermined time intervals. For example, a system controller or a computing device may recalculate the temperature and current values of T and L at any suitable number of seconds, or other time periods, during the fabrication of a three dimensional object.

In some examples, the characteristic of the three dimensional object can include a depth of a layer being fabricated with the heating source. In some examples, the characteristic of the three dimensional object can include a material of a layer being fabricated with the heating source. For example, the temperature and current values of T and L can be modified based on the depth of a layer or a material in a layer of a three dimensional object because a different optical power may be needed to melt the layer and generate the three dimensional object. In some examples, each layer of a three dimensional object can be fabricated with a different material and a different depth.

As discussed above, the process 200 can adjust the voltage provided to the heating source without detecting sensor data from a color temperature sensor or an optical power sensor. Rather, the process 200 can include adjusting the voltage provided to a heating source based on a detected electrical current and electrical voltage in combination with the temperature component T and current component L calculated above in relation to block 202. Accordingly, the process 200 can reduce latency in fabricating a three dimensional object by preventing any wait time or polling time associated with detecting sensor data from color temperature sensors and optical power sensors.

The description of process 200 in FIG. 2 is not intended to indicate that blocks 202-208 are to be executed in any particular order. In some examples, block 204 can be executed prior to block 202. Furthermore, the process 200 may include any number of additional blocks. For example, the process 200 can also include preventing a pause of fabrication of a three dimensional object to detect sensor data. For example, the color temperature sensor and the optical power sensor may not receive power during the fabrication of a three dimensional object because color temperature values and optical power values are not needed to adjust the voltage applied to the heating source. In some examples, the heating source resides in a lamp carriage with additional heating sources. For example, the heating source may reside in a lamp carriage with one, two, three, four, or any other suitable number of heating sources. In some examples, the process 200 can include adjusting the fabrication voltage of each heating source within the lamp carriage. In some examples, the process 200 can include adjusting the fabrication voltage of each heating source separately or the process 200 can include adjusting the fabrication voltage of the heating sources in the lamp carriage simultaneously. In some examples, the process 200 can detect electrical current values and electrical voltage values for each heating source within a lamp carriage at the same predetermined time interval or different predetermined time intervals. The process 200 can also include staggering the times at which a system controller detects electrical current values and electrical voltage values. For example, the process 200 may detect electrical current and electrical voltage values for a first heating source at a first time, and detect electrical current and electrical voltage values for a second heating source at a second time, etc.

FIG. 3 is a block diagram of an example computing system that can fabricate a three dimensional object. The computing system 300 may include, for example, a server computer, a mobile phone, laptop computer, desktop computer, or tablet computer, among others. In some examples, the computing system 300 can be any suitable fabrication device such as a three dimensional printer, among others. The computing system 300 may include a processor 302 that is adapted to execute stored instructions. The processor 302 can be a single core processor, a multi-core processor, a computing cluster, or any number of other appropriate configurations.

The processor 302 may be connected through a system bus 304 (e.g., AMBA®, PCI®, PCI Express®, Hyper Transport®, Serial ATA, among others) to an input/output (I/O) device interface 306 adapted to connect the computing system 300 to one or more I/O devices 308. The I/O devices 308 may include, for example, a pointing device, wherein the pointing device may include a touchpad or a touchscreen, among others. The I/O devices 308 may be built-in components of the computing system 300, or may be devices that are externally connected to the computing system 300.

The processor 302 may also be linked through the system bus 304 to a display device interface 310 adapted to connect the computing system 300 to display device 312. The display device 312 may include a display screen that is a built-in component of the computing system 300. The display device 312 may also include computer monitors, televisions, or projectors, among others, that are externally connected to the computing system 300. Additionally, the processor 302 may also be linked through the system bus 304 to a network interface card (also referred to herein as NIC) 314. The NIC 314 may be adapted to connect the computing system 300 through the system bus 304 to a network (not depicted). The network may be a wide area network (WAN), local area network (LAN), or the Internet, among others.

The processor 302 may also be linked through the system bus 304 to a memory device 316. In some examples, the memory device 316 can include random access memory (e.g., SRAM, DRAM, eDRAM, EDO RAM, DDR RAM, RRAM®, PRAM, among others), read accessible memory (e.g., Mask ROM, EPROM, EEPROM, among others), non-volatile memory (PCM, STT_MRAM, ReRAM, Memristor), or any other suitable memory systems.

In some examples, the processor 302 may also be linked through the system bus 304 to a storage device 318. The storage device 318 can include any suitable number of software modules or applications. For example, a calibration application 320 can calibrate the system to detect a temperature component and a current component by operating a heating source 322 with at least two different calibration voltages and monitoring a color temperature of the heating source 322 and an optical power of the heating source 322 at each of the at least two different calibration voltages. The heating source 322 can include any suitable bulb, such as a quartz infrared tungsten lamp, among others. In some examples, the computing system 300 can include any suitable number of heating sources 322 in a lamp carriage (not depicted). The heating source 322 can be located proximate a surface on which layers of material are placed to be melted to form a three dimensional object. In some examples, the heating source 322 can reside in a fabrication device attached to the computing system 300 as an I/O device 308. In some examples, the heating source 322 can also reside in a fabrication device electronically coupled to the NIC 314 via any suitable network, remote computing device, or remote fabrication device, among others.

In some examples, a fabrication application 324 can perform a three dimensional printing operation while applying a fabrication voltage to the heating source. In some examples, the fabrication application 324 can also monitor the fabrication voltage and a current of the heating source 322 during the three dimensional printing operation or fabrication of the three dimensional object. Furthermore, in some examples, the fabrication application 324 can adjust the fabrication voltage of the heating source 322 in response to a change in a resistance of the heating source 322 or a characteristic of the three dimensional object, wherein the fabrication voltage is adjusted based at least on the temperature component and the current component.

It is to be understood that the block diagram of FIG. 3 is not intended to indicate that the computing system 300 is to include all of the components shown in FIG. 3. Rather, the computing system 300 can include fewer or additional components not illustrated in FIG. 3 (e.g., additional memory devices, video cards, additional network interfaces, additional software applications, heating sources, etc.). Furthermore, any of the functionalities of the calibration application 320 and the fabrication application 324 may be partially, or entirely, implemented in hardware and/or in the processor 302. For example, the functionality can be implemented with an application specific integrated circuit, in logic implemented in the processor 302, or in any other suitable device.

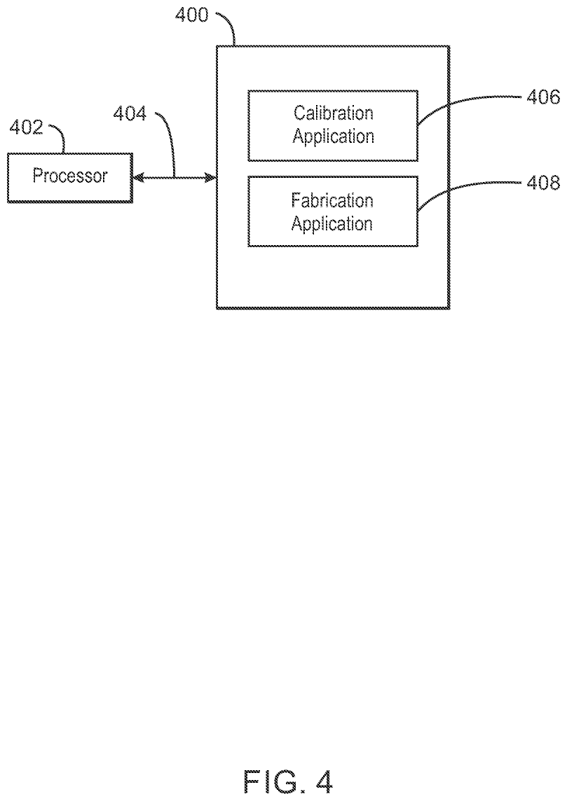

FIG. 4 is a non-transitory computer-readable medium for providing instructions to fabricate a three dimensional object. The tangible, non-transitory, computer-readable medium 400 may be accessed by a processor 402 over a computer bus 404. Furthermore, the tangible, non-transitory, computer-readable medium 400 may include computer-executable instructions to direct the processor 402 to perform the blocks of the current method.

The various software components discussed herein may be stored on the tangible, non-transitory, computer-readable medium 400, as indicated in FIG. 4. For example, a calibration application 406 can calibrate the system to detect a temperature component and a current component by operating a heating source with at least two different calibration voltages and monitoring a color temperature of the heating source and an optical power of the heating source at each of the at least two different calibration voltages. In some examples, a fabrication application 408 can perform a three dimensional printing operation while applying a fabrication voltage to the heating source. In some examples, the fabrication application 408 can also monitor the fabrication voltage and a current of the heating source during the three dimensional printing operation. Furthermore, in some examples, the fabrication application 408 can also adjust the fabrication voltage of the heating source in response to a change in a resistance of the heating source or a characteristic of the three dimensional object, wherein the fabrication voltage is adjusted based at least on the temperature component and the current component. It is to be understood that any number of additional software components not shown in FIG. 4 may be included within the tangible, non-transitory, computer-readable medium 400, depending on the specific application.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A system for fabricating three dimensional objects comprising:
a processor to:
calibrate the system to detect a temperature component and a current component by operating a heating source with at least two different calibration voltages and monitoring a color temperature of the heating source and an optical characteristic of the heating source at each of the at least two different calibration voltages;
perform a three dimensional printing operation while applying a fabrication voltage to the heating source;
monitor the fabrication voltage and a current of the heating source during the three dimensional printing operation; and
adjust the fabrication voltage of the heating source in response to a change in a resistance of the heating source, wherein the fabrication voltage is adjusted based at least on the temperature component and the current component.

2. The system of claim 1, wherein the heating source is a quartz infrared tungsten lamp.

3. The system of claim 1, wherein the processor is to detect a nominal resistance of the heating source based on the at least two different voltages applied to the heating source during the calibrating of the system.

4. The system of claim 1, wherein the system comprises a color temperature sensor to detect the color temperature of the heating source and a visible optical power sensor to detect the optical characteristic of the heating source.

5. The system of claim 1, wherein the processor is to adjust the fabrication voltage of the heating source in response to a change in a characteristic of the three dimensional object comprising a depth of a layer being fabricated with the heating source.

6. The system of claim 1, wherein the processor is to adjust the fabrication voltage of the heating source in response to a change in a characteristic of the three dimensional object comprising a material of a layer being fabricated with the heating source.

7. The system of claim 1, wherein the heating source resides in a lamp carriage with additional heating sources.

8. The system of claim 1, wherein the processor is to prevent pausing the three dimensional printing operation to detect sensor data.

9. A method for fabricating three dimensional objects comprising:
calibrating a system to detect a temperature component and a current component by operating a heating source with at least two different calibration voltages and monitoring a color temperature of the heating source and an optical power of the heating source at each of the at least two different calibration voltages;
performing a three dimensional printing operation while applying a fabrication voltage to the heating source;
monitoring the fabrication voltage and a current of the heating source during the three dimensional printing operation; and
adjusting the fabrication voltage of the heating source in response to a change in a resistance of the heating source or a characteristic of the three dimensional object, wherein the fabrication voltage is adjusted based at least on the temperature component and the current component.

10. The method of claim 9, wherein the heating source is a quartz infrared tungsten lamp.

11. The method of claim 9, comprising detecting a nominal resistance of the heating source based on the at least two different voltages applied to the heating source during the calibrating of the system.

12. The method of claim 9, wherein the characteristic of the three dimensional object comprises a depth of a layer being fabricated with the heating source.

13. The method of claim 9, wherein the characteristic of the three dimensional object comprises a material of a layer being fabricated with the heating source.

14. The method of claim 9, comprising preventing a pause of the three dimensional printing operation to detect sensor data.

15. A non-transitory computer-readable medium comprising a plurality of instructions that, in response to being executed by a processor, cause the processor to:
calibrate a system to detect a temperature component and a current component by operating a heating source with at least two different calibration voltages and monitoring a color temperature of the heating source and an optical power of the heating source at each of the at least two different calibration voltages;
perform a three dimensional printing operation while applying a fabrication voltage to the heating source;
monitor the fabrication voltage and a current of the heating source during the three dimensional printing operation; and
adjust the fabrication voltage of the heating source in response to a change in a resistance of the heating source or a characteristic of the three dimensional object, wherein the fabrication voltage is adjusted based at least on the temperature component and the current component, and wherein the characteristic of the three dimensional object comprises a depth of a layer being fabricated with the heating source.
